(19) United States
(12) Patent Application Publication
(10) Pub. No.: US 2016/0241760 A1
(43) Pub. Date: Aug. 18, 2016

(54) DISPLAY HAVING AN INTEGRATED CAMERA

(71) Applicant: INTEL CORPORATION, Santa Clara, CA (US)

(72) Inventor: Yoon Pheng Law, Bayan Lepas (MY)

(21) Appl. No.: 14/383,066

(22) PCT Filed: Dec. 27, 2013
(86) PCT No.: PCT/IB2013/002876

§ 371 Date: Sep. 4, 2014

(51) Int. Cl. H04N 5/225; G06F 1/16; H04N 5/232

(52) U.S. Cl. CPC H04N 5/2257; H04N 5/23293; H04N 5/2254; G06F 1/1686; G02B 5/08

(57) ABSTRACT

Briefly, in accordance with one or more embodiments, a display comprises an array of display elements, one or more camera sensors, and one or more reflecting mirrors, wherein light that is to enter the display is to be directed by at least one of the one or more reflecting mirrors to at least one of the one or more camera sensors, and light that is to emanate from the one or more display elements is to pass through at least one of the one or more reflecting mirrors to exit the display. The camera sensors may be integrated within the display as a functional camera such that a user viewing the display may not notice or detect the presence of the camera, and the camera does not interfere with the operation of display.

### BACKGROUND OF THE INVENTION

Displays typically include some sort of camera that is physically disposed outside the display area such as on the bezel surrounding the display area. As a result, the resulting display housing may be slightly larger than it otherwise could be since the camera is disposed outside of the display area. Furthermore, the camera may be visible despite efforts to hide the opening in the bezel for the camera which may detract from the appearance of the display.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a front view of a display having an integrated camera in accordance with one or more embodiments;

FIG. 2 is a front view of a system comprising a keyboard and a display having an integrated camera in accordance with one or more embodiments;

FIG. 3 is a side view of a camera sensor assembly for a pixel of a display including a camera sensor in accordance with one or more embodiments;

FIG. 4A and 4B are diagrams of the components utilized to fabricate a camera sensor assembly as shown in FIG. 3 in accordance with one or more embodiments;

FIG. 5 is a side view of a display having a camera sensor at selected pixels in accordance with one or more embodiments; and

FIG. 6 a block diagram of an information handling system capable of utilizing a display having an integrated camera in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

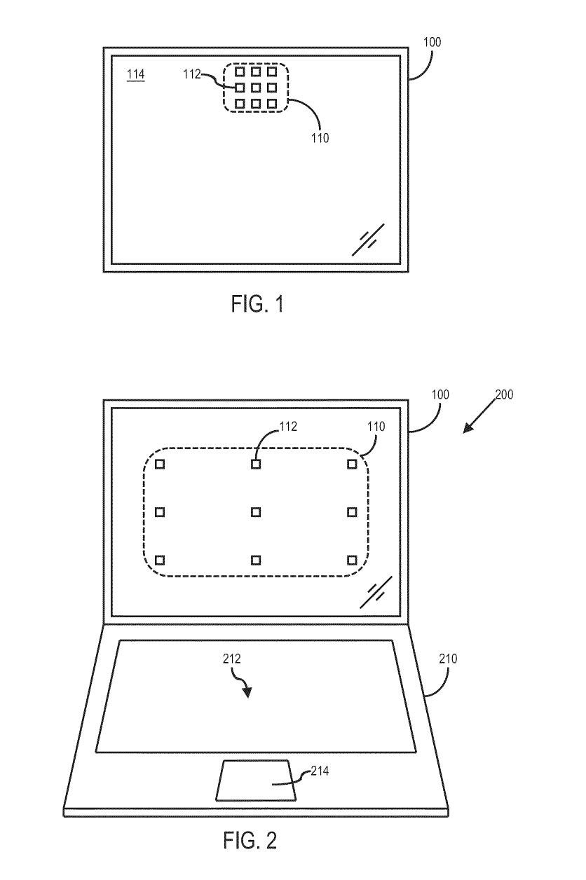

Referring now to FIG. 1, a front view of a display having an integrated camera in accordance with one or more embodiments will be discussed. As shown in FIG. 1, display 100 may include an integrated camera 110 comprising an array of camera sensors 112 integrated with one or more pixels of display 100. In one or more embodiments, camera sensors 112 may comprise any suitable type of image sensor technology, for example a charge-coupled device (CCD) or complementary metal-oxide-semiconductor (CMOS) sensor, and the scope of the claimed subject matter is not limited in this respect. For purpose of example, camera 110 is shown comprising a 3×3 array of camera sensors 112 which are not necessarily shown to scale. It should be noted that camera 110 may comprise any number of camera sensors 112 in any various pattern or distribution, and with any number of camera sensors 112, and the scope of the claimed subject matter is not limited in this respect. In one embodiment, the camera 110 may be located within a selected region of display 100, for example centrally located near a top portion of display glass 114 and situated behind and/or interior to display glass 114. In such an embodiment, the camera sensors 112 may be spaced generally closer together in a more concentrated pattern. In other embodiments, for example as shown in FIG. 2, below, the camera sensors 112 may be generally spaced apart in a more distributed pattern. In general, there camera sensors 112 may be arranged in any pattern, spacing or concentration. In some embodiments there is one camera sensor 112 for each corresponding pixel of display 100 such that the number of camera sensors 112 equals or nearly equals the number of pixels of display 100, and the scope of the claimed subject matter is not limited in these respects. In the embodiment shown in FIG. 1, display 100 may comprise a stand-alone display capable of being connected to another device such as a personal computer, notebook computer, cable or satellite television converter box, internet television box, and so on, that provides a video signal to be displayed on display 100. Alternatively, display 100 may comprise a stand-alone device such as a cell phone, smart phone, tablet, personal computer in a tablet form factor, and so on, and the scope of the claimed subject matter is not limited in these respects. It should be noted that in some embodiments the camera sensors 112 are integrated within display 100 such that a user viewing the display 100 may not notice or detect the presence of the camera 110, and the camera 110 does not interfere with the operation of display 100.

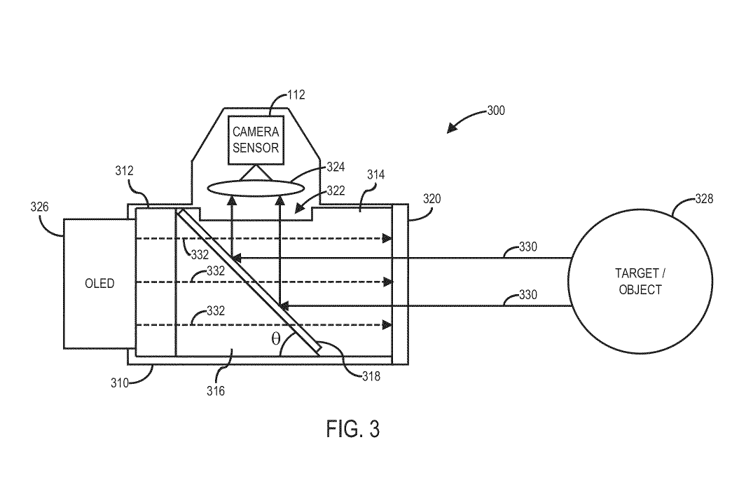

Referring now to FIG. 2, a front view of a system comprising a keyboard and a display having an integrated camera in accordance with one or more embodiments will be discussed. Display 100 of FIG. 2 is substantially similar to display 100 of FIG. 1, except that in FIG. 2 camera 110 of display 100 comprises a distributed arrangement of camera sensors 112 for purposes of example. Furthermore, display 100 may be part of a system 200 comprising display 100 and keyboard unit 210 that is attached to display 100 or otherwise capable of being coupled with display 100. For example, system 200 may comprise a notebook computer, Ultrabook™ system, or a convertible computer. Alternatively, display 100 may comprise a tablet or tablet computer that is capable of coupling with keyboard unit 210 to provide a notebook like form factor. Keyboard unit 210 may include a keyboard 212, a track pad 214, and/or one or more input buttons (not shown) in some embodiments. These examples are merely various form factors of system 200 that may utilize display 100 having an integrated camera 110, and the scope of the claimed subject matter is not limited in these respects. It should be noted that although FIG. 2 shows a camera 110 having a distributed arrangement of camera sensors 112, this is merely for purposes of example, and display 100 of FIG. 1 may likewise be utilized with system 200, and the scope of the claimed subject matter is not limited in this respect. An example of a camera sensor assembly suitable for utilization with display 100 is shown in and described with respect to FIG. 3, below.

Referring now to FIG. 3, a side view of a camera sensor assembly for a pixel of a display including a camera sensor in accordance with one or more embodiments will be discussed. As shown in FIG. 3, camera sensor assembly 300 comprises a jacket 310 or housing to contain a first fiber optic 312, a second fiber optic 314 and a mirror glass 316. Mirror glass 316 may comprise a transparent or at least partially transparent material such as glass, plastic, or a composite material. Mirror glass 316 further may include a reflective coating 318 such that light rays impinging on reflective coating 318 from one direction may be reflected off the surface of reflective coating 318, and light rays impinging on reflective coating 318 after passing through mirror glass 316 may pass through reflective coating 318. In other words, mirror glass 316 and reflective coating 318 may function as a two-way mirror as will be discussed in further detail, below.

A cover glass 320 may be disposed adjacent to second fiber optic 314 and may comprise a separate piece of cover glass, plastic or composite material, or may comprise the cover glass, plastic or composite material that is the display glass 114 of display 100. Second fiber optic 314 further may comprise an open valve 322 formed in second fiber optic 314 to facilitate light rays exiting from and/or entering into second fiber optic 314. In one or more embodiments, camera sensor 112 may be coupled with camera sensor assembly 300 adjacent to open valve 322. Furthermore, a focus lens 324 may be disposed adjacent to camera sensor 112 between open valve 322 and camera sensor 112. In one or more embodiments, light rays 330 that emanate from or off of a target or object 328 may enter camera sensor assembly 300 through cover glass 320, pass through second fiber optic 314 and impinge on reflective coating 318. Since mirror glass 316 and reflective coating 318 are disposed at an angle, θ, the light rays 330 reflect off of reflective coating 318 and are redirected toward camera sensor 112. The light rays 330 exit second fiber optic 314 via open valve 322 and are focused onto camera sensor 112 via focus lens 324. In addition, a display element 326 corresponding to a pixel of display 100 is disposed at one end of camera sensor assembly 300 adjacent to first fiber optic 312. The display element 326 may comprise an organic light emitting diode (OLED) or similar device, and the scope of the claimed subject matter is not limited in this respect.

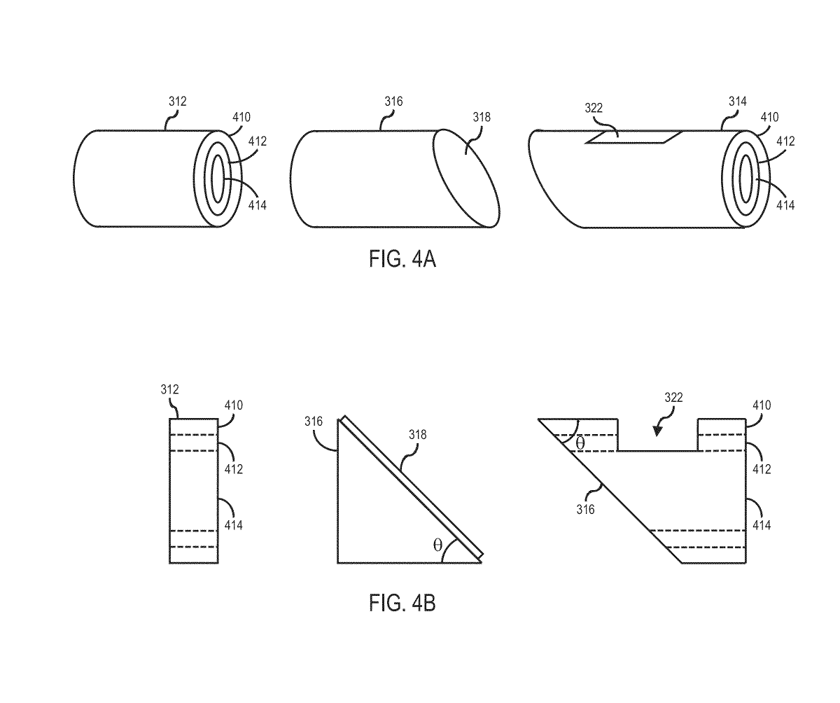

Light rays 332 emanating from the display element enter camera pixel assembly 300 through first fiber optic 312, passing through mirror glass 316 and second fiber optic 320 to exit camera sensor assembly 300 and pass through cover glass 320 for normal pixel operation. An example of how the components of camera sensor assembly 300 may be configured is shown in and described with respect to FIG. 4A and FIG. 4B, below.

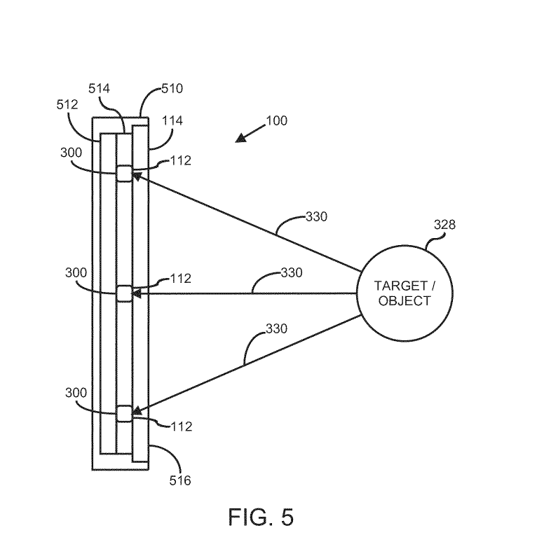

Referring now to FIG. 4A and 4B, diagrams of the components utilized to fabricate a camera sensor assembly as shown in FIG. 3 in accordance with one or more embodiments will be discussed. As shown in both FIG. 4A and 4B, first fiber optic 312 may comprise a buffer 410, a cladding 412, and a core 414, and may be formed to couple with mirror glass 316. Mirror glass 316 may have a surface formed at an angle, θ, which may have a reflective coating 318 formed on the angled surface. Likewise, second fiber optic 314 may have a surface formed at an angle, θ, to couple with the angled surface of mirror glass 316. Furthermore, second fiber optic 314 may have open valve 322 formed therein, and similar to first fiber optic 312 may comprise a buffer 410, a cladding 412, and a core 414. The individual components as of FIG. 4A and FIG. 4B may be formed and assembled, for example using an optically transparent adhesive, to result in camera sensor assembly 300 as shown in and described with respect to FIG. 3, above. The camera sensor assembly 300 may be integrated with a corresponding pixel of display 100 in an array of display elements of display 100 which may include one or more camera sensor assemblies 300, for example as shown in and described with respect to FIG. 5, below.

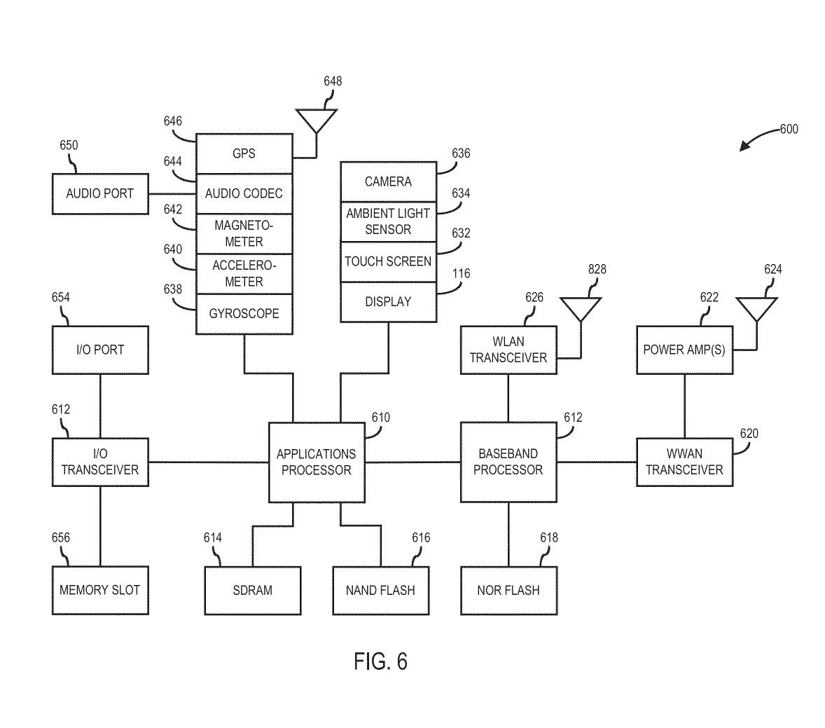

Referring now to FIG. 5, a side view of a display having a camera sensor at selected pixels in accordance with one or more embodiments will be discussed. FIG. 5 shows a side cutaway view of display 100 comprising housing 510 to house an array of display elements 512, an intermediate layer 514, and a display glass 114. The array of display elements 512 may comprise an array of display elements 326 as shown in FIG. 3, for example a thin film transistor (TFT) layer comprising an array of organic light emitting diodes (OLEDs) and corresponding control transistors or the like. Intermediate layer 514 may comprise a layer to interface the array of display elements 512 with display glass 114, and may comprise a transparent material for example an indium tin oxide (ITO) material, or a plastic or composite material, although the scope of the claimed subject matter is not limited in this respect. One or more camera sensor assemblies 300 comprising one or more camera sensors 112 may be disposed in intermediate layer 514. In one or more embodiments, a display element 326 of the array of display elements 512 may couple with a corresponding camera sensor assembly 300 as shown in FIG. 3, and/or the cover glass 320 of FIG. 3 may correspond to the display glass 114 of FIG. 5. In one or more embodiments, display 100 further may comprise a touch screen 516 to allow a user to provide an input via the touch screen 516. It should be noted that in some embodiments the camera sensors 112 are integrated within display 100 such that a user viewing the display 100 may not notice or detect the presence of the camera 110, and the camera 110 does not interfere with the operation of display 100. Display 100 may be part of an information handling system as shown in and described with respect to FIG. 6, below.

Referring now to FIG. 6 a block diagram of an information handling system capable of utilizing a display having an integrated camera in accordance with one or more embodiments will be discussed. Information handling system 600 of FIG. 6 may tangibly embody the electronic components of an electronic device utilizing display 100 as shown in FIG. 1 and FIG. 2 with greater or fewer components depending on the hardware specifications of the particular device. Although information handling system 600 represents one example of several types of computing platforms, information handling system 600 may include more or fewer elements and/or different arrangements of elements than shown in FIG. 6, and the scope of the claimed subject matter is not limited in these respects.

In one or more embodiments, information handling system 600 may include an applications processor 610 and a baseband processor 612. Applications processor 610 may be utilized as a general-purpose processor to run applications and the various subsystems for information handling system 600. Applications processor 610 may include a single core or alternatively may include multiple processing cores wherein one or more of the cores may comprise a digital signal processor or digital signal processing (DSP) core.

Furthermore, applications processor 610 may include a graphics processor or coprocessor disposed on the same chip, or alternatively a graphics processor coupled to applications processor 610 may comprise a separate, discrete graphics chip. Applications processor 610 may include on board memory such as cache memory, and further may be coupled to external memory devices such as synchronous dynamic random access memory (SDRAM) 614 for storing and/or executing applications during operation, and NAND flash 616 for storing applications and/or data even when information handling system 600 is powered off. In one or more embodiments, instructions to operate or configure the information handling system 600 and/or any of its components or subsystems to operate in a manner as described herein may be stored on an article of manufacture comprising a non-transitory storage medium. In one or more embodiments, the storage medium may comprise any of the memory devices shown in and described herein, although the scope of the claimed subject matter is not limited in this respect. Baseband processor 612 may control the broadband radio functions for information handling system 600. Baseband processor 612 may store code for controlling such broadband radio functions in a NOR flash 618. Baseband processor 612 controls a wireless wide area network (WWAN) transceiver 620 which is used for modulating and/or demodulating broadband network signals, for example for communicating via a 3GPP LTE or LTE-Advanced network or the like.

In general, WWAN transceiver 620 may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 620 couples to one or more power amps 622 respectively coupled to one or more antennas 624 for sending and receiving radio-frequency signals via the WWAN broadband network. The baseband processor 612 also may control a wireless local area network (WLAN) transceiver 626 coupled to one or more suitable antennas 628 and which may be capable of communicating via a Wi-Fi, Bluetooth®, and/or an amplitude modulation (AM) or frequency modulation (FM) radio standard including an IEEE 802.11 a/b/g/n standard or the like. It should be noted that these are merely example implementations for applications processor 610 and baseband processor 612, and the scope of the claimed subject matter is not limited in these respects. For example, any one or more of SDRAM 614, NAND flash 616 and/or NOR flash 618 may comprise other types of memory technology such as magnetic memory, chalcogenide memory, phase change memory, or ovonic memory, and the scope of the claimed subject matter is not limited in this respect.

In one or more embodiments, applications processor 610 may drive a display 110 for displaying various information or data, and may further receive touch input from a user via a touch screen 632 for example via a finger or a stylus. An ambient light sensor 634 may be utilized to detect an amount of ambient light in which information handling system 600 is operating, for example to control a brightness or contrast value for display 100 as a function of the intensity of ambient light detected by ambient light sensor 634. One or more cameras 110 may be utilized to capture images that are processed by applications processor 610 and/or at least temporarily stored in NAND flash 616. Furthermore, applications processor may couple to a gyroscope 638, accelerometer 640, magnetometer 642, audio coder/decoder (CODEC) 644, and/or global positioning system (GPS) controller 646 coupled to an appropriate GPS antenna 648, for detection of various environmental properties including location, movement, and/or orientation of information handling system 600. Alternatively, controller 646 may comprise a Global Navigation Satellite System (GNSS) controller. Audio CODEC 644 may be coupled to one or more audio ports 650 to provide microphone input and speaker outputs either via internal devices and/or via external devices coupled to information handling system via the audio ports 650, for example via a headphone and microphone jack. In addition, applications processor 610 may couple to one or more input/output (I/O) transceivers 612 to couple to one or more I/O ports 654 such as a universal serial bus (USB) port, a high-definition multimedia interface (HDMI) port, a serial port, and so on. Furthermore, one or more of the I/O transceivers 612 may couple to one or more memory slots 656 for optional removable memory such as secure digital (SD) card or a subscriber identity module (SIM) card, although the scope of the claimed subject matter is not limited in these respects.

Example implementations of a display having an integrated camera may be as follows. In a first example, a display comprise an array of display elements, one or more camera sensors, and one or more reflecting mirrors, wherein light that is to enter the display is to be directed by at least one of the one or more reflecting mirrors to at least one of the one or more camera sensors, and light that is to emanate from the one or more display elements is to pass through at least one of the one or more reflecting mirrors to exit the display. The one or more camera sensors may be disposed in a selected region of the display. The one or more camera sensors may be disposed in a distributed arrangement in the display. The display elements may comprise organic light emitting diodes. The one or more camera sensors may be disposed in an intermediate layer between the array of display elements and a front layer of the display. One or more of the reflecting mirrors may be disposed between a first fiber optic and a second fiber optic to form a camera sensor assembly. The display further may comprise one or more focusing lenses disposed between one or more of the reflecting mirrors and one or more of the camera sensors to focus incoming light rays on the one or more camera sensors. The display further may comprise a touch screen to allow a user to provide an input via the touch screen.

In a second example, an information handling system comprises a display and a keyboard unit. The display may comprise the example implementations as discussed, above.

In a third example, a camera sensor assembly to integrate with a display comprises a camera sensor, a reflecting mirror having a first surface and a second surface disposed at an angle with respect to the first surface, a first fiber optic to conduct light from the first surface of the reflecting mirror, and a second fiber optic having a surface disposed at an angle to conduct light from the second surface of the reflecting mirror. Light rays emitted from a display element of the display may be capable of entering the first fiber optic to pass through the reflecting mirror and exit through the second fiber optic, and light may be capable of entering the second fiber optic to be reflected off the reflecting mirror to the camera sensor. The reflecting mirror may have a reflective coating disposed on the second surface. The second fiber optic may have an open valve formed thereon to facilitate light reflected off the reflecting mirror to exit the second fiber optic. The camera sensor assembly further may comprise a focusing lens to focus light rays reflecting off the reflecting mirror on the camera sensor.

In a fourth example, a display comprises means to generate a pixel, means to convert at least a portion of an optical image into an electronic signal, and means to reflect light, wherein light that is to enter the display is to be directed the light reflecting means to the converting means, and light that is to emanate from the pixel generating means is to pass through the light reflecting means to exit the display. One or more of the light converting means may be disposed in a selected region of the display. Two or more of the light converting means may be disposed in a distributed arrangement in the display. The pixel generating means comprises one or more organic light emitting diodes. The converting means may be disposed in an intermediate layer between the pixel generating means and a front layer of the display. The reflecting means may be disposed between a first fiber optic and a second fiber optic to form a camera sensor assembly. The display further may comprise means to focus light rays, disposed between the light reflecting means and the converting means, to focus incoming light rays on the converting means. The display further may comprise a touch screen to allow a user to provide an input via the touch screen.

In a fifth example, a method to operate a display comprises generating a pixel as light that is to emanate from the pixel to exit the display, reflecting light that is to enter the display, and converting at last a portion of the entering light into an electronic signal. The reflecting may occur in a selected region of the display, or in a distributed manner in the display. The converting may occur in an intermediate layer of the display. The reflecting may occur between a first fiber optic and a second fiber optic. The method further may comprise focusing incoming light rays to facilitate said converting.

Although the claimed subject matter has been described with a certain degree of particularity, it should be recognized that elements thereof may be altered by persons skilled in the art without departing from the spirit and/or scope of claimed subject matter. It is believed that the subject matter pertaining to a display having an integrated camera and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

1-34. (canceled)

35. A display, comprising:
an array of display elements;
one or more camera sensors; and
one or more reflecting mirrors, wherein light that is to enter the display is to be directed by at least one of the one or more reflecting mirrors to at least one of the one or more camera sensors, and light that is to emanate from the one or more display elements is to pass through at least one of the one or more reflecting mirrors to exit the display.

36. A display as claimed in claim 35, wherein the one or more camera sensors are disposed in a selected region of the display.

37. A display as claimed in claim 35, wherein the one or more camera sensors are disposed in a distributed arrangement in the display.

38. A display as claimed in claim 35, wherein the display elements comprise organic light emitting diodes.

39. A display as claimed in claim 35, wherein the one or more camera sensors are disposed in an intermediate layer between the array of display elements and a front layer of the display.

40. A display as claimed in claim 35, wherein one or more of the reflecting mirrors is disposed between a first fiber optic and a second fiber optic to form a camera sensor assembly.

41. A display as claimed in claim 35, further comprising one or more focusing lenses disposed between one or more of the reflecting minors and one or more of the camera sensors to focus incoming light rays on the one or more camera sensors.

42. A display as claimed in claim 35, further comprising a touch screen to allow a user to provide an input via the touch screen.

43. An information handling system, comprising:
a display; and
a keyboard unit;
wherein the display comprises:
an array of display elements;
one or more camera sensors; and
one or more reflecting minors, wherein light that is to enter the display is to be directed by at least one of the one or more reflecting mirrors to at least one of the one or more camera sensors, and light that is to emanate from the one or more display elements is to pass through at least one of the one or more reflecting mirrors to exit the display.

44. An information handling system as claimed in claim 43, wherein one or more camera sensors are disposed in a selected region of the display.

45. An information handling system as claimed in claim 43, wherein one or more camera sensors are disposed in a distributed arrangement in the display.

46. An information handling system as claimed in claim 43, wherein one or more of the display elements comprise organic light emitting diodes.

47. An information handling system as claimed in claim 43, wherein one or more of the camera sensors are disposed in an intermediate layer between the array of display elements and a front layer of the display.

48. An information handling system as claimed in claim 43, wherein one or more reflecting mirrors are disposed between a first fiber optic and a second fiber optic to form a camera sensor assembly.

49. An information handling system as claimed in claim 43, further comprising one or more focusing lenses disposed between one or more reflecting minors and one or more camera sensors to focus incoming light rays on one or more camera sensors.

50. An information handling system as claimed in claim 43, further comprising a touch screen to allow a user to provide an input via the touch screen.

51. A camera sensor assembly to integrate with a display, comprising:
a camera sensor;
a reflecting minor having a first surface and a second surface disposed at an angle with respect to the first surface;
a first fiber optic to conduct light from the first surface of the reflecting mirror; and
a second fiber optic having a surface disposed at an angle to conduct light from the second surface of the reflecting minor;
wherein light rays emitted from a display element of the display is capable of entering the first fiber optic to pass through the reflecting minor and exit through the second fiber optic, and light is capable of entering the second fiber optic to be reflected off the reflecting minor to the camera sensor.

52. A camera sensor assembly as claimed in claim 51, wherein the reflecting mirror has a reflective coating disposed on the second surface.

53. A camera sensor assembly as claimed in claim 51, wherein the second fiber optic has an open valve formed thereon to facilitate light reflected off the reflecting mirror to exit the second fiber optic.

54. A camera sensor assembly as claimed in claim 51, further comprising a focusing lens to focus light rays reflecting off the reflecting mirror on the camera sensor.
